(19) United States
(12) Patent Application Publication
(10) Pub. No.: US 2006/0256867 A1
(43) Pub. Date: Nov. 16, 2006

(54) Content-adaptive multiple description motion compensation for improved efficiency and error resilience

(76) Inventors: Deepak S. Turaga, San Jose, CA (US); Mihaela Van Der Schaar, New York, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/526,861

(22) PCT Filed: Aug. 29, 2003
(86) PCT No.: PCT/IB03/03952

§ 371 Date: Mar. 4, 2005

Related U.S. Application Data
(60) Provisional application No. 60/408,913, filed on Sep. 6, 2002.
(60) Provisional application No. 60/483,775, filed on Jun. 30, 2003.

(51) Int. Cl. H04N 11/02

(52) U.S. Cl. 375/240.16

(57) ABSTRACT

A multiple description coding method is applied to video, and optimized to preclude transmission to the decoder of mismatch correction information that applies to portions of a frame outside a region of interest. Additional bit efficiency is realized by selectively updating, based on video content, the weighting of prediction frames motion compensated from corresponding frames used in estimating a current frame. Frequency of update is adaptively determined based on the realized increased accuracy of prediction and concomitant residual image bit savings as compared, in tradeoff, with the need to more frequently transmit the updated weights to the receiver.

The present invention relates to video encoding and particularly to multiple description coding of video.

Transmit diversity, transmitting the same or similar information over multiple independent channels, attempts to overcome the inability to correctly receive a message due to problems on one of the channels. Such problems in a wireless transmission context can occur as a result of multipath or fading, for example.

The added redundancy, however, comes at a cost in terms of added strain on the communication system. This is particularly true for video, which tends to involve a lot of data for its proper representation. The recipient typically wants to decode efficiently to avoid interruption of the presentation. Moreover, since there are typically more recipients than transmitters, cost efficiency often allows more time and resources to be expended in encoding than in decoding.

Multiple description coding (MDC) sends two “descriptions” of the information to be conveyed along separate channels. If both descriptions are received, the decoding will be of high quality. If only one description is received, it can be decoded with less, but acceptable, quality. This ability to rely on one description is made possible by providing each description with information from the other channel. Therefore, error resilience is increased, albeit at the cost of redundancy and the concomitant overhead.

MDC has been applied to video to achieve multiple description motion compensation “Error Resilient Video Coding Using Multiple Description Motion Compensation”, IEEE Transactions on Circuits and Systems for Video Technology, April, 2002, by Yao Wang and Shunan Lin, hereinafter “Wang and Lin,” the entire disclosure of which is incorporated herein by reference. Motion compensation is a conventional technique used for efficiently encoding and decoding video by predicting that image motion implied by adjacent frames will continue at the same magnitude and in the same direction and accounting for prediction error. Multiple description motion compensation (MDMC), as proposed by Wang and Lin, splits a video stream into odd and even frames for transmission by separate channels. Even if only one description arrives at the receiver, that description's frames have been independently motion compensated at the transmitter and can therefore be restored by conventional motion compensation at the receiver, with the intervening frames being interpolated. In tradeoff for the added error resilience, interpolation falls short of actually having the missing frame information. The error is mitigated by including redundant information in each description about the other description. To gather and assemble this redundant information, Wang and Lin MDMC employs a second-order predictor, i.e. predicts a frame based on the previous two frames, to suppress transmission error propagation. This robust, second-order predictor is utilized in a separate, third motion compensation know as a “central motion compensation.” The central motion compensation operates on all of the frames, both odd and even. As occurs in conventional motion compensation, a difference between a predicted frame and the actual frame is sent as an error or residual, in this case a “central error,” to the receiver, which ordinarily would make an identical prediction and add the error to restore the original frame. If, however, if one description is missing, central motion compensation at the receiver is disabled since it requires both the odd and even frames. On the other hand, both the odd and even motion compensations at the receiver are configured for using the respective odd or even error, known as the “side error,” generated at the transmitter and cannot instead substitute the central error without incurring a mismatch.

To reduce this mismatch, Wang and Lin invariably transmit as redundant information both the central error and the difference between the side error and central error, this difference being known as the “mismatch error.” Yet, the mismatch error represents overhead that is not always needed for effective video presentation at the receiver.

Moreover, the Wang and Lin central prediction employs a weighted average that is insensitive to ongoing changes in the content of the video being encoded, even when those changes call for updating of the weights to achieve more efficiency.

The present invention is directed to overcoming the above-mentioned shortcomings of the prior art.

In one aspect according to the present invention, there is provided a method and apparatus for encoding in parallel by two motion compensation processes to produce two respective streams to be transmitted to a decoder. Each stream includes a mismatch signal usable by the decoder to reconstruct a part of the video sequence motion compensated to produce the other stream.

In another aspect of the invention, a central prediction image is formed to represent a weighted average of frames motion compensated in the central motion compensation, where the average is weighted by respective adaptive temporal filter tap weights that are updated based on content of at least one frame of the sequence.

In a further aspect of the invention, a frequency at which the taps are to be updated is determined based on a decrease in the residual image due to the updating and consequent decrease in bits to be transmitted in the transmission. The determination is further based on an increase in bit rate in transmitting new adaptive temporal filter tap weights in response to the updating.

In yet another aspect of the invention, identification of a ROI is performed by detecting at least one of a face of a person, uncorrelated motion, a predetermined level of texture, an edge, and object motion of a magnitude greater than a predefined threshold.

In a yet further aspect of the present invention, there is provided a multiple description video decoder for motion compensation decoding two video streams in parallel. The decoder uses a mismatch signal, received from a motion compensation encoder that produced the streams, to reconstruct a part of the video sequence motion compensated to produce the other stream. The decoder includes means for receiving tap weights updated by the encoder based on content of the video streams and used by the decoder to make an image prediction based on both of the streams.

Details of the invention disclosed herein shall be described with the aid of the figures listed below, wherein like features are numbered identically throughout the several views:

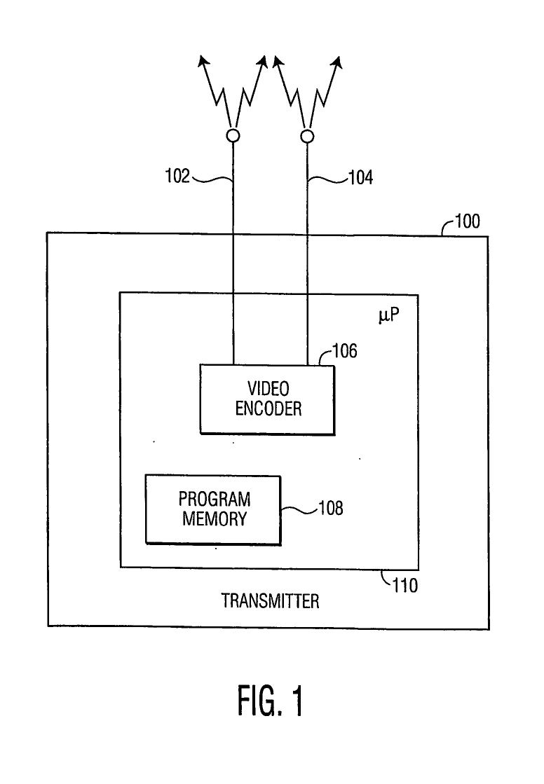

FIG. 1 is a block diagram of a multiple-antenna transmitter using an exemplary video encoder in accordance with the present invention;

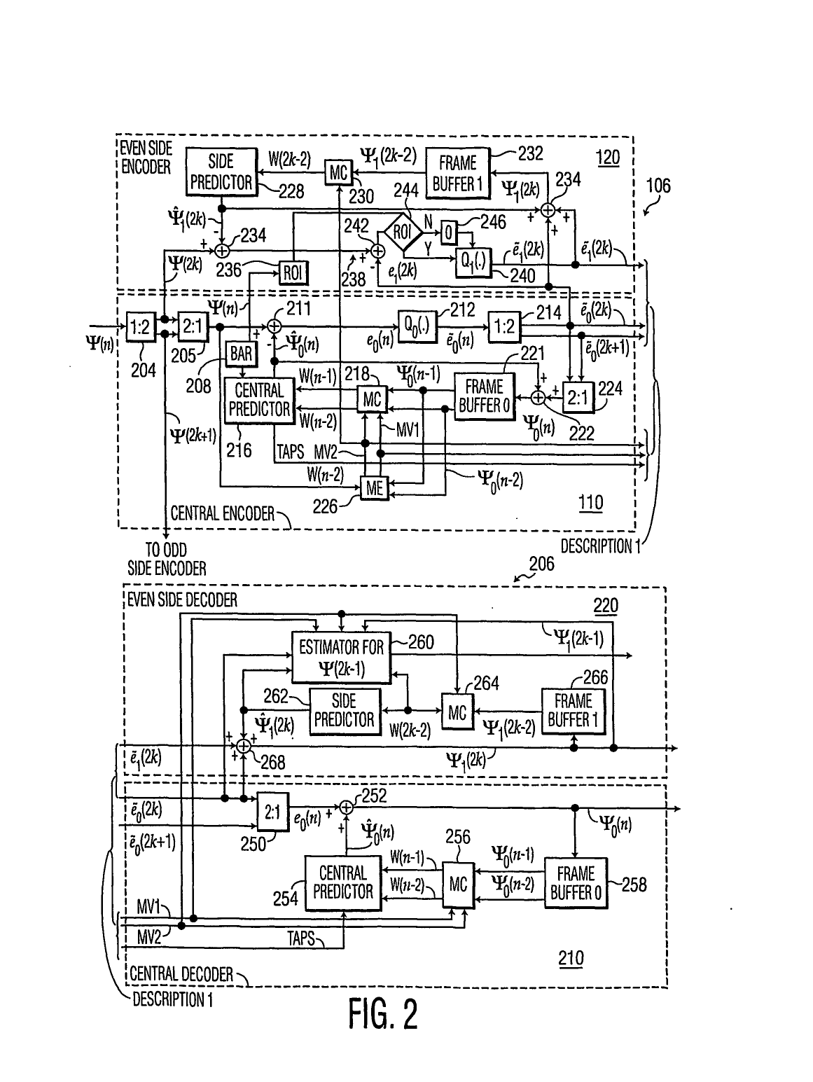

FIG. 2 is a block diagram showing an example of one configuration of the video encoder of FIG. 1, and of a corresponding decoder, in accordance with the present invention;

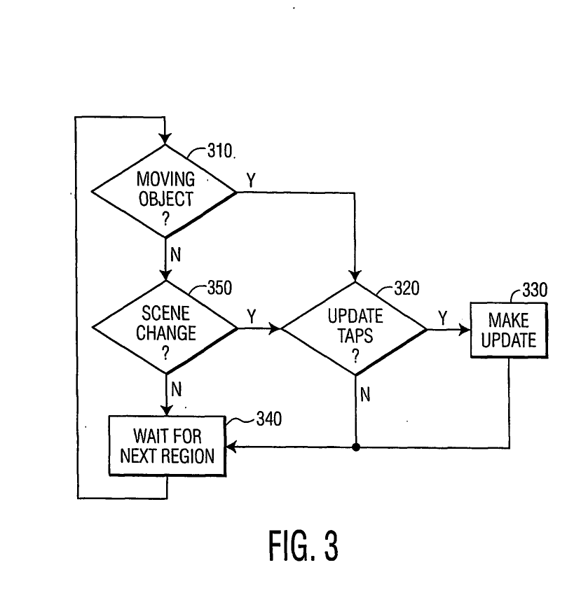

FIG. 3 is a flow diagram depicting, as an example, events that can trigger an update of tap weights for the central predictor in accordance with the present invention;

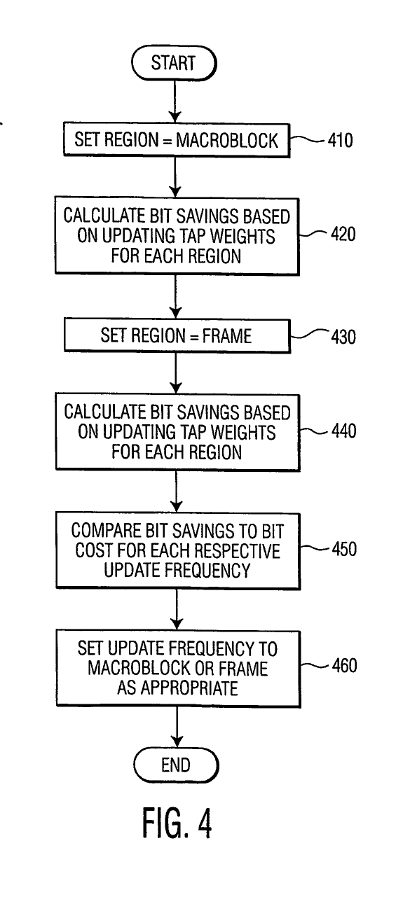

FIG. 4 is a flow chart illustrating one type of algorithm for determining how frequently tap weights for the central predictor are to be updated in accordance with the present invention; and

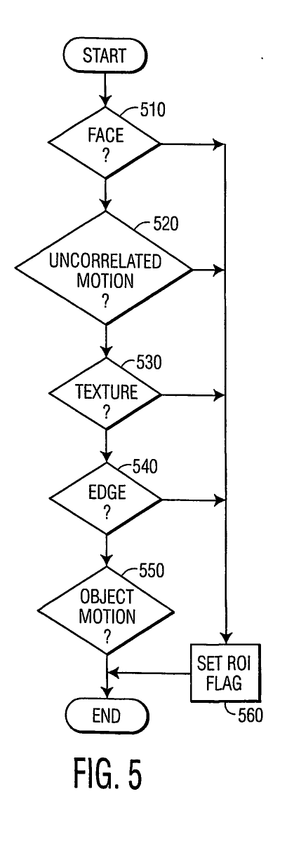

FIG. 5 is a flow chart showing, as an example, content-based factors that can be used in identifying a region of interest in accordance with the present invention.

FIG. 1 depicts, by way of example and in accordance with the present invention, a wireless transmitter 100 such as a television broadcast transmitter having multiple antennas 102, 104 connected to a video encoder 106 and an audio encoder (not shown). The latter two are incorporated along with a program memory 108 within a microprocessor 110. Alternatively, the video encoder 106 can be hard-coded in hardware for greater execution speed as a trade-off against upgradeability, etc.

FIG. 2 illustrates in detail the components and the functioning of the video encoder 106 and of a video decoder 206 at a receiver in accordance with the present invention. The video encoder 106 is comprised of a central encoder 110, an even side encoder 120 and an odd side encoder (not shown). The central encoder 110 operates in conjunction with the even side encoder 120 and analogously in conjunction with the odd side encoder. Correspondingly, in the video decoder 206, a central decoder 210 operates in conjunction with an even side decoder 220 and analogously in conjunction with an odd side decoder (not shown).

The central encoder 110 includes an input 1:2 demultiplexer 204, an encoder input 2:1 multiplexer 205, a bit rate regulation unit 208, an encoding central input image combiner 211, a central coder 212, an output 1:2 demultiplexer 214, a encoding central predictor 216, an encoding central motion compensation unit 218, an encoding central frame buffer 221, a central reconstruction image combiner 222, a reconstruction 2:1 multiplexer 224 and a motion estimation unit 226.

The even side encoder 120 includes an encoding even side predictor 228, an encoding even side motion compensation unit 230, an encoding even side frame buffer 232, an encoding even input image combiner 234, a region of interest (ROI) selection unit 236, a mismatch error suppression unit 238 and an even side coder 240. The mismatch error suppression unit 238 is composed of a side-to-central image combiner 242, and ROI comparator 244, and an image precluder 246.

A video frame ψ(n) of a video sequence 1 . . . ψ(n-1), ψ(n) . . . is received by the input 1:2 demultiplexer. If the frame is even, the frame ψ(2k) is demultiplexed to the encoding even input image combiner 234. Otherwise, if the frame is odd, the frame ψ(2k+1) is demultiplexed to the analogous structure in the odd side encoder. Division into even and odd frames preferably separates out every other frame, i.e. alternates frames, to create odd frames and even frames, but can be done arbitrarily in accordance of any downsampling to produce one subset, the remainder of the frames comprising the other subset.

The output frame ψ(n) from the encoder input 2:1 multiplexer 205 is then subject to both motion compensation and ROI analysis, both processes preferably being executed in parallel. Motion compensation in accordance with the present invention largely follows conventional motion compensation as performed in accordance with any of the standards H.263, H.261, MPEG-2, MPEG-4, etc.

At the start of motion compensation, the encoding central input image combiner 211 subtracts a central prediction image Ŵ₀(n) from ψ(n) to produce an uncoded central prediction error or residual e₀(n). The uncoded central prediction error e₀(n) is inputted to the central coder 212 which includes both a quantizer and an entropy encoder. The output is central prediction error \tilde{e}₀(n), which the output 1:2 demultiplexer 214 transmits to the decoder 206 as \tilde{e}₀(2k) or \tilde{e}₀(2k+1) as appropriate.

In addition, either \tilde{e}₀(2k) or \tilde{e}₀(2k+1) as appropriate is fed back in the central motion compensation by the reconstruction 2:1 multiplexer 224. The central reconstruction image combiner 222 adds this feedback error to the central prediction image \tilde{W}₀(n) to reconstruct the input frame ψ(n) (with quantization error). The reconstructed frame ψ₀(n) is then stored in the encoding central frame buffer 221.

In deriving the central prediction image Ŵ₀(n) to be applied as described above, the previous two reconstructed frames ψ₀(n-1), ψ₀(n-2) and the input frame ψ(n) were compared by motion estimation unit 226 to derive respective motion vectors MV1s and MV2s. That is, the motion vectors MV1s, for example, each pertain to a luminance macroblock, i.e. a 16×16 array of pixels, of the current frame ψ(n). An exhaustive, or merely predictive, search is made of all 16×16 macroblocks in ψ₀(n-1) that are in a predetermined neighborhood or range of the macroblock being searched. The closest matching macroblock is selected, and a motion vector MV1 from the macroblock in ψ(n) to the selected macroblock in ψ₀(n-1) is thus derived. This process is carried out for each luminance macroblock of ψ(n). To derive MV2 the process is carried out once again, but this time from ψ₀(n-1) to ψ₀(n-2), and the delta is added to MV1 to produce MV2, i.e., MV2 has twice the dynamic range and MV1. The MV1s and MV2s are both output to the decoder 206.

The encoding central motion compensation unit 218 also receives the MV1s and MV2s, as well as the reconstructed frame pair ψ₀(n-1), ψ₀(n-2) and updates, i.e. motion compensates, the reconstructed frames based on the MV1s and MV2s to resemble the incoming ψ(n). The updating assumes that motion in the recent frame sequence of the video will continue to move in the same direction and with the same velocity. The encoding central predictor 216 forms a weighted average of the respective motion compensated frames W(n-1), W(n-2) to produce the central prediction image Ŵ₀(n). In particular Ŵ₀(n) is set equal to a, W(n-1)+a₂ W(n-2), with a₁+a₂=1. The coefficients a₁, a₂ are referred to hereinafter as temporal filter tap weights.

As mentioned above, the use of two previous frames rather than the conventional use of merely the previous frame provides error resilience at the receiver. Moreover, if both the even and odd video channels arrive at the receiver intact, a corresponding central decoding at the receiver will decode successfully. However, if either the even or the odd video channel does not arrive successfully due to environment or other factors, a frame buffer at the receiver which tracks the encoding central decoder's frame buffer 221 will not receive a reconstructed or “reference” frame, and this deficiency will prevent the decoder 206 from using a corresponding central decoding to correctly decode the received signal. Accordingly, the encoder 106 includes two additional independent motion compensations, one that operates only on the odd frames and another that operates only on the even frames, all three compensations running in parallel. Thus, if the odd description is corrupt or missing, the receiver can decode the even description, and vice versa.

Discussion of the role of the bit rate regulation unit 208 in central motion compensation and of ROI processing will be deferred to first describe in greater detail the workings of the even side encoder 120 and the decoder 206.

In the even side encoder 120, the encoding even image input combiner 234 subtracts from the input signal ψ(2k) a side prediction image Ŵ₁(n). The subscript 1 indicates even side processing and the subscript 2 indicates odd side processing, just as the subscript 0 has been used above to denote central processing. The side-to-central image combiner 242 subtracts the central prediction error \tilde{e}₀(2k) from the side prediction error outputted by the even image input combiner 234. The side-to-central difference image, or “mismatch error” or “mismatch signal” e₁(2k) represents the difference between the side prediction image Ŵ₁(2k) and the central prediction image Ŵ₀(2k) and is, after ROI processing, then subject to quantization and entropy coding by the even side coder 240 to produce \tilde{e}₁(2k). The mismatch error signal \tilde{e}₁(2k) is transmitted to the decoder 206, and is indicative of mismatch between reference frames in the encoder 106 and decoder 206, much of which the decoder offsets based on this signal.

The encoding even input image combiner 234 adds the side prediction image Ŵ₁(n) to the central and mismatch errors \tilde{e}₀(2k), \tilde{e}₁(2k) to reconstruct the input frame ψ(2k) which is then stored in the encoding even side frame buffer 232. The side prediction image Ŵ₁(n) used to generate the mismatch error \tilde{e}₀(2k) was derived by motion compensating the previously reconstructed frame ψ₁(2k−2) in the encoding even side motion compensation unit 230 and, based on the resulting motion compensated frame W(2k−2), making a side prediction in the encoding even side predictor 228. The side prediction preferably consists of multiplying W(2k−2) by a coefficient a₃ between 0 and 1 and preferably equal to 1.

The even description is formed from the central prediction error \tilde{e}₀(2k) and the mismatch error \tilde{e}₁(2k), whereas the odd description is formed from the central prediction error \tilde{e}₀(2k+1) and the mismatch error \tilde{e}₂(2k+1). Included in both descriptions are the motion vectors MV1s and MV2s, as well as the temporal filter tap weights which as will be explained in more detail below are adjustable according to image content.

The central decoder 206 has an entropy decoding and inverse quantizing unit (not shown), a decoder input 2:1 multiplexer 250, a decoding central image combiner 252, a decoding central predictor 254, a decoding central motion compensation unit 256 and a decoding central frame buffer 258. The received central prediction error and mismatch error, after entropy decoding and inverse quantization, are multiplexed by the decoder input 2:1 multiplexer 250 to produce, as appropriate, either \tilde{e}₀(2k) or \tilde{e}₀(2k+1). From these error signals, and a central prediction, each frame is reconstructed, outputted to the user, and stored for subsequent motion compensation to reconstruct the next frame, all performed in a manner analogous to the motion compensation at the encoder 120. The entropy decoding and inverse quantizing, which initially receives each description upon its arrival at the decoder 206, preferably incorporates a front end that has error checking capabilities and signaling to the user regarding the detection of any error. Accordingly, the user will ignore the flagged description as improperly decoded, and utilize the other description. Of course, if both descriptions are received successfully, the output of the central decoder 210 will be better than that of either decoded description and will be utilized instead.

The even side decoder 220 includes an intervening frame estimator 260, a decoding even side predictor 262, a decoding even side motion compensation unit 264, a decoding even side frame buffer 266 and a decoding input even side image combiner 268. The functioning of the even side decoder 220 is analogous to that of the even side encoder 120, although the even side decoder has the further task of reconstructing the odd frames, i.e. the frames of the odd description. A motion compensated intervening frame W(2k−1) is reconstructed according to the formula W(2k−1)=(1/a₁)(ψ₁(2k)−a₂W(2k−2)−\tilde{e}₀(2k)). Further refinement steps in the reconstructing the missing frame based on the MV1s and MV2s are discussed in the Wang and Lin reference.

Some of the frames to be encoded, intra-coded frames, are encoded in their entirety, and are therefore not subject to motion compensation which involves finding a difference from a predicted frame and encoding the difference. The intra-coded frames appear periodically in the video sequence and serve to refresh the encoding/decoding. Accordingly, although not shown in FIG. 2, both the encoder 120 and the decoder 220 are configured to detect intra-coded frames and to set the output of the predictors 216, 228, 254, 262 to zero for intra-coded frames.

FIG. 3 is a flow diagram depicting, by way of example, events that can trigger an update of the temporal tap weights for the central predictor in accordance with the present invention. At one extreme, setting a₁ to 1 is tantamount to mailing a central prediction based merely on the preceding frame, and therefore foregoes the robustness of second-order prediction. As a result, larger residual images are transmitted at the expense of efficiency. At the other extreme, setting a₂ to 1 eliminates the information that the mismatch signal would otherwise afford in accurately reconstructing intervening frames. Error resilience is therefore compromised. Wang and Lin determines values for a₁ and a₂ based on a rate distortion criterion, and retains these weights for the entire video sequence. However, such a fixed weighting scheme can lead to large amounts of inefficiency. For instance, in frames with moving objects occlusions occur often. In such cases it is likely that a better match for the block in frame n may be obtained from frame n-2 instead of frame n-1. Accordingly, a higher a₂ emphasizes frame n-2 and therefore leads to transmission of less of a residual image to the decoder 206. Conversely, if a scene change is occurring in the video, frame n-1 may provide a much closer prediction than does frame n-2, in which case a high a₁ and a low a₂ are desirable. Advantageously, the present invention monitors the content of the video and adaptively adjusts the temporal filter tap weights in accordance.

Step 310 detects the existence in a frame of a moving object by, for example, examining motion vectors of a current frame and all previous frames extending back to the previous reference frame using techniques discussed in U.S. Pat. No. 6,487,313 to De Haan et al. and U.S. Pat. No. 6,025,879 to Yoneyama et al., hereinafter “Yoneyama,” the entire disclosure of both being incorporated herein by reference. The foregoing moving object detection algorithms are merely exemplary and any other conventional methods may be employed. If a moving object is detected, a determination is made in step 320 as to whether tap weights should be updated, e.g., if sufficient efficiency would be gained from an update. The detection and determination are both made by the bit rate regulation (BRR) unit 208, which receives, stores and analyzes original frames ψ(n). If tap weights are to be updated, step 330 makes the updates. If not, the next region, preferably a frame, is examined. If, on the other hand, the BRR unit 208 does not detect a moving object, step 350 determines whether a scene change is occurring. Scene change detection can be performed by motion compensating a frame to compare it to a reference frame and determining that motion compensation has occurred if the sum of non-zero pixels differences exceeds a threshold, as disclosed in U.S. Pat. No. 6,101,222 to Dorricott, the entire disclosure of which is incorporated herein by reference, or by other suitable known means. If, in step 350, the BRR unit 208 determines that a scene change has occurred, processing proceeds to step 320 to determine whether taps are to be updated.

The update frequency for the tap weights need not be limited each frame; instead, taps may adaptively be updated for each macroblock or for any arbitrarily chosen region. Adaptive choice of weights can improve coding efficiency, however there is some overhead involved in the transmission of the selected weights that may become significant at extremely low bit rates. The selection of the region size over which to use the same temporal weights is dependent on this tradeoff between overhead and coding efficiency.

FIG. 4 illustrates one type of algorithm by which the BRR unit 208 can determine how frequently tap weights for the central predictor are to be updated in accordance with the present invention. In step 410, the update frequency is initially set to every macroblock, and step 420 estimates the bit savings over a period of time or over a predetermined number of frames. The estimate can be made empirically, for example, based on recent experience and updated on a continuing basis. The next two steps 430, 440 make the same determination with the update frequency being set to each frame. In step 450, a determination, for each of the two frequencies, of the bit overhead in updating the decoder 206 with the new tap weights is compared to the respective bit savings estimates to decide which update frequency is more efficient. The frequency determined to be more efficient is set in step 460.

In accordance with the present invention, additional or alternative bit efficiency in the transmission from the encoder 106 to the decoder 206 can be realized, since it is not necessary to transmit the mismatch error for every block in the frame. Many times, especially under error prone conditions, it is acceptable to have better quality for some regions (e.g. foreground) as compared to others (e.g. background). In effect, the mismatch error need be retained only for regions of interest (ROIs) in the scene, the ROIs being identified based on the content of the video. In conformity with block-based coding schemes, the ROIs can be delimited within a frame by bounding boxes, but the intended scope of the invention is not limited to the rectangular configuration.

FIG. 5 shows, by way of example, content-based factors that can be used by the ROI selection unit 236 in identifying ROIs in accordance with the present invention. The ROI selection unit 236, like the BRR unit 208, is configured to receive, store and analyze original frames ψ(n). The ROI comparator compares the identified ROIs to the side-to-central difference image outputted by the side-to-central image combiner 242 to determine which part of the image lies outside the ROIs. That part is set to zero by the image precluder 246, thereby limiting the mismatch error to be transmitted to that part of the mismatch error within the ROIs.

In step 510, the face of a person, which need not be any specific individual, is identified. On method provided in U.S. Pat. No. 6,463,163 to Kresch, the entire disclosure of which is incorporated herein by reference, uses correlation in the DCT domain. In step 520, uncorrelated motion is detected. This can be performed by splitting a frame into regions whose size varies with each iteration, and, in each iteration, searching for regions whose motions vectors have a variance that exceeds a predetermined threshold. Step 530 detects regions with texture, since lack of one description at the receiver would require interpolation the missing frames that would benefit significantly from the mismatch error. Yoneyama discloses a texture information detector based on previous frames extending to the previous reference frame and operating in the DCT domain. Edges often are indicative of high spatial activity and therefore of ROIs. Step 540 detects edges, and can be implemented with the edge detection circuit of Komatsu in U.S. Pat. No. 6,008,866, the entire disclosure of which is incorporated herein by reference. The Komatsu circuit detects edges by subjecting a color-decomposed signal to band-pass filtering, magnitude normalizing the result and then comparing to a threshold. This technique or any known and suitable method may be employed. Finally, fast object motion, which is indicative of high temporal activity and therefore of ROIs, can be detected by detecting a moving object as described above and comparing motion vectors to a predetermined threshold. If any of the above indicators of an ROI are determined to exist, in step 560 an ROI flag is set for the particular macroblock ROIs within a bounding box may be formed based on the macroblocks flagged within the frame.

As has been demonstrated above, a multiple description motion compensation scheme in an encoder is optimized to save bits in communicating with the decoder by updating, based on video content, the weighting of prediction frames by which the central prediction is derived, and by precluding, based on video content and for those areas of the frame not falling with a region of interest, transmission of a mismatch signal for enhancing decoder side prediction.

While there have been shown and described what are considered to be preferred embodiments of the invention, it will, of course, be understood that various modifications and changes in form or detail could readily be made without departing from the spirit of the invention. For example, the selectively precluded mismatch signal may be configured to serve a decoder arranged to receive more than two descriptions of the video sequence. It is therefore intended that the invention be not limited to the exact forms described and illustrated, but should be constructed to cover all modifications that may fall within the scope of the appended claims.

1. A multiple description video encoding method comprising the steps of:
identifying based on content of a frame at least one region of interest (ROI) in said frame, said frame being one of a plurality of frames comprising a video sequence being encoded in parallel by two motion compensation processes to produce two respective streams to be transmitted to a decoder, each stream including a mismatch signal usable by the decoder to reconstruct a part of the video sequence motion compensated to produce the other stream;
determining, for said frame, a portion of said mismatch signal that resides outside said at least one ROI; and
precluding from the transmission said portion.

2. The method of claim 1, wherein the video sequence includes an odd stream and an even stream that are motion compensated in parallel for subsequent transmission on separate channels, the odd stream comprising a downsampled subset of the plural frames, the even stream comprising those of the plural frames that are not in the subset, each stream further comprising upon said transmission a residual image from a central motion compensation executing in parallel with the odd and even stream compensations and upon each stream, motion vectors and, except where precluded, said mismatch signal, said mismatch signal being representative of a difference between a side prediction image and a central prediction image, said side prediction image being derived based on the motion compensation of the respective one of the odd and even streams, said central prediction image being derived based on said central motion compensation.

3. The method of claim 2, wherein said central prediction image is subtracted from an original image to produce said residual image.

4. The method of claim 2, wherein said motion vectors comprise a motion vector between temporally consecutive frames of said video stream and wherein said motion vectors comprise a motion vector between frames temporally separated by one intervening frame in said video stream.

5. The method of claim 1, wherein said identifying step further comprises a step selected from the group consisting of detecting a face of a person, detecting uncorrelated motion, detecting a predetermined level of texture, detecting an edge and detecting object motion of a magnitude greater than a predefined threshold.

6. A multiple description video encoding method comprising the steps of:
forming a side prediction image by motion compensating a single frame of a video sequence; and
forming a central prediction image from a weighted average of frames motion compensated in a central motion compensation in parallel with the motion compensation that forms the side prediction image, the average being weighted by respective adaptive temporal filter tap weights that are updated based on content of at least one frame of said sequence.

7. The method of claim 6, wherein said content of at least one frame includes the presence of a moving object, or the occurrence of scene change, in an image derived from said at least one frame.

8. The method of claim 6, wherein the video sequence includes an odd stream and an even stream that are motion compensated in parallel for subsequent transmission on separate channels, the odd stream comprising a downsampled subset of the plural frames, the even stream comprising those of the plural frames that are not in the subset, each stream further comprising upon said transmission motion vectors, a residual image from a central motion compensation executing in parallel with the odd and even stream compensations and upon each stream, and a mismatch signal that is representative of a difference between the side prediction image and the central prediction image, said side prediction image being derived based on the motion compensation of the respective one of the odd and even streams, said central prediction image being derived based on said central motion compensation.

9. The method of claim 8, further including the step of determining a frequency at which the taps weights are to be updated based on a decrease in the residual image due to the updating and consequent decrease in bits to be transmitted in said transmission and based on an increase in bit rate in transmitting new adaptive temporal filter tap weights in response to the updating.

10. A multiple description video encoder comprising:
an odd side encoder and an even side encoder for performing on frames of a video sequence motion compensation in parallel to produce two respective streams to be transmitted to a decoder, each stream including a mismatch signal usable by the decoder to reconstruct a part of said video sequence motion compensated to produce the other stream;
a region of interest (ROI) selection unit for identifying based on content of a frame at least one ROI in said frame; and
a mismatch error suppression unit for determining, for said frame, a portion of said mismatch signal that resides outside said at least one ROI and precluding from the transmission said portion.

11. The video encoder of claim 10, wherein said motion compensation in parallel operates on an odd video stream and an even video stream for subsequent transmission on separate channels, the odd stream comprising a downsampled subset of frames of said video sequence, the even stream comprising those frames of the sequence that are not in the subset, each stream further comprising upon said transmission a residual image from a central motion compensation executing in parallel with the odd and even stream compensations and upon each stream, motion vectors and, except where precluded, said mismatch signal, said mismatch signal being representative of a difference between a side prediction image and a central prediction image, said side prediction image being derived based on the motion compensation of the respective one of the odd and even streams, said central prediction image being derived based on said central motion compensation.

12. The video encoder of claim 11, wherein said subset is comprised of alternate frames of said sequence so that each of the odd and even video streams includes every other frame of said sequence.

13. The video encoder of claim 11, wherein said central encoder is configured for subtracting said central prediction image from an original image to produce said residual image.

14. The video encoder of claim 11, wherein said motion vectors comprise a motion vector between temporally consecutive frames of said video stream and wherein said motion vectors comprise a motion vector between frames temporally separated by one intervening frame in said video stream.

15. The video encoder of claim 10, wherein said ROI selection unit is configured for detecting at least one of a face of a person, uncorrelated motion, a predetermined level of texture, an edge, and object motion of a magnitude greater than a predefined threshold.

16. A multiple description video encoder comprising:
an odd side encoder and an even side encoder for performing on frames of a video sequence motion compensation in parallel to produce two respective streams to be transmitted to a decoder, each stream including a mismatch signal usable by the decoder to reconstruct a part of said video sequence motion compensated to produce the other stream;
means for forming a side prediction image by motion compensating a single frame of said sequence; and
means for forming a central prediction image from a weighted average of frames motion compensated in a central motion compensation, the average being weighted by respective adaptive temporal filter tap weights that are updated based on content of at least one frame of said sequence.

17. The video encoder of claim 16, wherein said content of at least one frame includes the presence of a moving object, or the occurrence of scene change, in an image derived from said at least one frame.

18. The video encoder of claim 16, wherein said motion compensation in parallel operates on an odd video stream and an even video stream for subsequent transmission on separate channels, the odd stream comprising a downsampled subset of frames of said video sequence, the even stream comprising those frames of the sequence that are not in the subset, each stream further comprising upon said transmission a residual image from a central motion compensation executing in parallel with the odd and even stream compensations and upon each stream, motion vectors and, except where precluded, a mismatch signal that is representative of a difference between a side prediction image and a central prediction image, said side prediction image being derived based on the motion compensation of the respective one of the odd and even streams, said central prediction image being derived based on said central motion compensation, said video encoder further including a bit rate regulation unit configured for determining a frequency at which the taps weights are to be updated based on a decrease in the residual image due to the updating and consequent decrease in bits to be transmitted in said transmission and based on an increase in bit rate in transmitting new adaptive temporal filter tap weights in response to the updating.

19. A computer software product that includes a medium readable by a processor and having stored thereon:
a first sequence of instructions which, when executed by said processor, causes said processor to identify based on content of a frame at least one region of interest (ROI) in said frame, said frame being one of a plurality of frames comprising a video sequence being encoded in parallel by two motion compensation processes to produce two respective streams to be transmitted to a decoder, each stream including a mismatch signal usable by the decoder to reconstruct a part of the video sequence motion compensated to produce the other stream; and
a second sequence of instructions which, when executed by said processor, causes said processor to determine, for said frame, a portion of said mismatch signal that resides outside said at least one ROI and to preclude from the transmission said portion.

20. The product of claim 19, wherein said first sequence of instructions comprises instructions, which when executed by the processor, cause the processor to detect at least one of a face of a person, uncorrelated motion, a predetermined level of texture, an edge, and object motion of a magnitude greater than a predefined threshold.

21. A multiple description video decoder for motion compensation decoding two video streams in parallel, the decoder using a mismatch signal, received from a motion compensation encoder that produced one of the streams, to reconstruct a sequence of video frames motion compensated to produce the other stream, said decoder comprising means for receiving tap weights updated by the encoder based on content of the video streams and used by the decoder to make an image prediction based on both of said streams.
